(19) United States
(12) Patent Application Publication
(10) Pub. No.: US 2007/0068353 A1
(43) Pub. Date: Mar. 29, 2007

(54) Machine for severing a web

(75) Inventors: Vincent A. Piucci, Spencer, MA (US); Charles R. Sperry, Leeds, MA (US); Michael J. Schamel, Wilmont, NH (US)

Correspondence Address: Thomas C. Lagaly;Sealed Air Corporation, P.O. Box 464, Duncan, SC, 29334, US

(73) Assignee: Sealed Air Corporation

(21) Appl. No.: 11/234,891

(22) Filed: Sep. 26, 2005

(51) Int. Cl. B26D 7/10; B26D 1/56

(52) U.S. Cl. 83/311; 83/171

(57) ABSTRACT

A machine for severing a web, comprising a movable surface positioned such that the web may exert gravitational force against the movable surface, the movable surface providing frictional force against the web such that movement of the surface causes movement of the web, and a severing mechanism to sever the web into selected lengths, the severing mechanism including a severing device that urges the web against the movable surface to effect the severance of the web.

### BACKGROUND OF THE INVENTION

The present invention relates to a machine for severing a web of material and, more particularly, to a simplified and improved apparatus and process for severing a web of cushioning material, especially a web of gas-containing cushioning material, such as foam or Bubble Wrap® cushioning material.

There often arises a need to sever a predetermined length of web from a larger supply of such material. For example, articles to be shipped in a container, e.g., a cardboard box, are often wrapped in a cushioning material inside of the container in order to protect the article during shipment. Such material often is supplied in the form of a continuous web from a source such as, e.g., a roll or folded stack. In order to sever an appropriate length of the material from the web, the packaging professional must make a transverse cut across the web or simply tear the web in a general direction which is transverse to the longitudinal dimension of the web, i.e., the direction from which the web is withdrawn from its source. Alternatively, the web of cushioning material may have a series of transverse perforation lines to facilitate tearing. In the case of Bubble Wrap® cushioning material, or other types of cushioning material containing individual cells or pockets of trapped gas, perforations are disadvantageous because any gas pockets contacted by the perforation lines become deflated, thereby reducing the number cells that are available for cushioning. In addition, the perforation lines are spaced at arbitrary intervals, which results in a lesser or greater length of cushioning material being torn from the web than would otherwise be desired in order to properly wrap the particular article in question.

As a result, various machines have been developed to provide automated severance of webs of cushioning material. One such machine, sold by Sealed Air Corporation under the trade name Instasheeter™ High-Speed Converting System, employs a pair of horizontally-oriented, counter-rotating conveyor belts that contact respective upper and lower surfaces of a horizontally-oriented web of cushioning material to convey such web through the machine. Downstream of the conveyor belts is a guillotine-type knife to sever the web into selected lengths. While this machine has worked well, it is more complex and expensive than would otherwise be desired for certain segments of the protective packaging market.

Accordingly, there is a need in the art for a simpler and less expensive web-severing machine, particularly one adapted to convey and sever webs of cushioning material, yet one that operates reliably and at a sufficiently high rate of speed to satisfy the requirements of the end-use packaging environment.

### SUMMARY OF THE INVENTION

Those needs are met by the present invention, which, in one aspect, provides a machine for severing a web, comprising:

a) a movable surface positioned such that the web may exert gravitational force against the movable surface, the movable surface providing frictional force against the web such that movement of the surface causes movement of the web, wherein, the gravitational force exerted by the web on the movable surface and the frictional force between the web and the movable surface are sufficient to allow the movable surface to convey the web; and

b) a severing mechanism to sever the web into selected lengths, the severing mechanism including a severing device that urges the web against the movable surface to effect the severance of the web.

Another aspect of the invention pertains to a machine for severing a web, comprising:

a) a movable surface positioned such that the web may exert gravitational force against the movable surface, the movable surface providing frictional force against the web such that movement of the surface causes movement of the web;

b) a guide member adjacent the movable surface to define a path for movement of the web between the movable surface and the guide member, the guide member being in sliding contact with the web; and

c) a severing mechanism to sever the web into selected lengths, the severing mechanism including a severing device that urges the web against the movable surface to effect the severance of the web.

Still another aspect of the invention is directed to a device for severing a web, comprising:

a) a heating element capable of reaching a temperature sufficient to sever the web when electrical current flows therethrough, the heating element being configured such that only a contact portion thereof makes contact with and effects severance of the web; and

b) two or more electrical nodes that are connectable with a source of electricity and in electrical communication with the heating element, the nodes being positioned relative to the heating element such that electrical current flows substantially only through the contact portion of the heating element.

These and other aspects and features of the invention may be better understood with reference to the following description and accompanying drawings.

### BRIEF DESCRIPTION OF THE DRAWING

FIG. 1 is a schematic, perspective view of one embodiment of a machine for severing a web in accordance with the present invention;

FIG. 2 is a side elevational view of the machine shown in FIG. 1;

FIG. 3 is a perspective view of a movable surface and severing mechanism which may be used in the machine of FIG. 1, shown in a “conveyance mode,” in which the web is being conveyed through the machine;

FIG. 4 is a side elevational view of FIG. 3;

FIG. 5 is similar to FIG. 3, except that is shows the movable surface and severing mechanism in a “severance mode,” in which the web is being severed to produce a web segment of a selected length;

FIG. 6 is similar to FIG. 3 but shows an alternative embodiment of the invention, wherein the machine includes a guide member;

FIG. 7 is a side elevational view of FIG. 6, showing a feature of the guide member, wherein the guide member is pivotally movable to facilitate web loading;

FIG. 8 is similar to FIG. 7, except that the guide member is in contact with the moving web;

FIGS. 9 and 10 are opposing perspective views of a working embodiment of the invention;

FIG. 11 is a perspective view of the drive and severing mechanisms of the machine illustrated in FIGS. 9 and 10 (movable surface and guide member not shown), wherein such mechanisms are in the “conveyance mode;”

FIG. 12 is a frontal perspective view of FIG. 11;

FIG. 13 is similar to FIG. 11, except that an end plate and cross-cut arm has been removed to show additional features;

FIG. 14 is a sectional, elevational view of FIG. 12;

FIG. 15 is similar to FIG. 11, except the drive and severing mechanisms are in the “severance mode;”

FIG. 16 is an elevational view of the cam plate shown in FIG. 13;

FIG. 17 is similar to FIG. 13, except only a cross-cut arm is removed to show a linear slot in the end plate; also, this view is from the opposing end of the machine;

FIG. 18 is a sectional view taken along lines 18-18 in FIG. 11;

FIG. 19 is a perspective view of a machine in accordance with the present invention with an alternative severing device;

FIG. 20 is a close-up view of the severing device shown in FIG. 20;

FIG. 21 is similar to FIG. 20, except that part of the device is removed for clarity;

FIG. 22 is plan view of a component of the device shown in FIG. 19;

FIG. 23 is a close-up view of the severing device shown in FIG. 22;

FIG. 24 is a perspective view of a support member component of the device shown in FIG. 22;

FIG. 25 is a close-up view of the indicated part of the support member shown in FIG. 24;

FIG. 26 is a longitudinal sectional view of the support member shown in FIG. 24;

FIG. 27 is a close-up sectional view of the indicated part of the support member shown in FIG. 26;

FIG. 28 is an alternative connector pin that may be used in the device shown in FIG. 19;

FIG. 29 is another alternative connector pin that may be used in the device shown in FIG. 19; and

FIG. 30 is a further alternative means for mounting the support member to the connector arm.

### DETAILED DESCRIPTION OF THE INVENTION

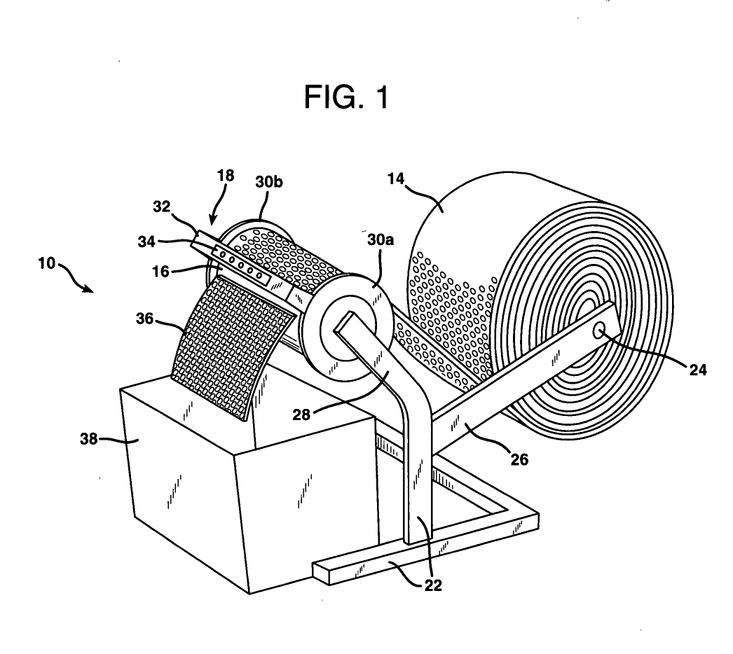

Referring to FIGS. 1-3, a machine 10 in accordance with the present invention for severing a web 12 is schematically illustrated. Web 12 may comprise a thermoplastic film comprising a plurality of gas-filled cells, such as Bubble Wrap® cushioning material, which is commercially available from Sealed Air Corporation. As shown, the bubble-containing web is supplied from a roll 14 of such material, which was previously manufactured at a separate location, e.g., a Sealed Air Corporation factory.

Alternatively, web 12 may comprise an inflatable cushioning web that is inflated and sealed on-site, and is fed from an inflation/sealing apparatus directly or indirectly, e.g., via a hopper or supply roll, to machine 10. Inflatable cushioning material of this type, as well as a machine and method for its inflation, is disclosed in U.S. Ser. No. 10/057,067, the disclosure of which is hereby incorporated herein by reference thereto. Such an inflatable web and inflation system is sold by Sealed Air Corporation under the trade name NewAir I.B.™ 200 packaging system. Machine 10 in accordance with the present invention may be used as a component of, or adjacent to, e.g., downstream of, such packaging system.

As a further alternative, web 12 may comprise a foam cushioning material, such as a web of polyolefin foam sheet comprising, e.g., polyethylene or polypropylene foam. Such material is sold by Sealed Air Corporation under the trade name Cell-Aire® Polyethylene Foam.

Web 12 may, in general, comprise any flexible material that can be manipulated by machine 10 as herein described, including various thermoplastic materials, e.g., polyethylene homopolymer or copolymer, polypropylene homopolymer or copolymer, etc. Non-limiting examples of suitable thermoplastic polymers include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, such as 1-butene, 1-pentene, 1-hexene, 1-octene, methyl pentene and the like, in which the polymer molecules comprise long chains with relatively few side chain branches, including linear low density polyethylene (LLDPE), linear medium density polyethylene (LMDPE), very low density polyethylene (VLDPE), and ultra-low density polyethylene (ULDPE). Various other polymeric materials may also be used such as, e.g., polypropylene homopolymer or polypropylene copolymer (e.g., propylene/ethylene copolymer), polyesters, polystyrenes, polyamides, polycarbonates, etc. The web may be a monolayer or multilayer film and/or foam, and can be made by any known extrusion process by melting the component polymer(s) and extruding, coextruding, or extrusion-coating them through one or more flat or annular dies.

Machine 10 generally includes a movable surface 16 positioned such that the web 12 may exert gravitational force against the movable surface 16. Further, movable surface 16 provides frictional force against the web such that movement of surface 16 causes movement of the web. In this embodiment, the combination of the gravitational force exerted by the web 12 on movable surface 16 and the frictional force between the web 12 and movable surface 16 are sufficient to allow the movable surface to convey the web.

Machine 10 also includes a severing mechanism 18 to sever the web 12 into selected lengths. Severing mechanism 18 generally includes a severing device 20 that urges the web 12 against movable surface 16 to effect the severance of the web. Severing device 20 may include a heated wire or other appropriate means, depending upon the composition of web 12, to melt, cut, or otherwise sever the web.

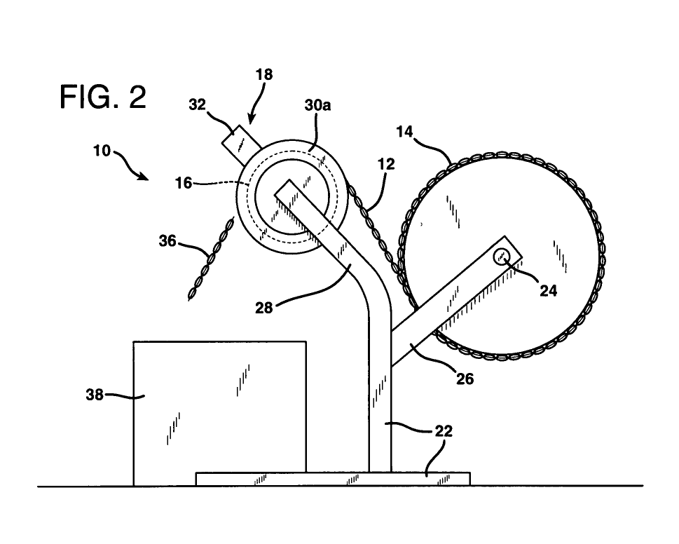

Many configurations for machine 10 are possible. In the embodiment shown in FIGS. 1-2, the movable surface 16 and severing mechanism 18 may be attached to a base frame 22. Roll 14 of web 12 may be rotatably supported by a spindle 24, which is attached to arm 26. Arm 26 may, in turn, be attached to, or an integral component of, base frame 22. Movable surface 16, which may be in the form of a rotatable cylinder as shown, may be rotatably supported by upper arm 28 of base frame 22. As will be described in more detail below, a drive mechanism to cause the rotation of the cylindrical-type movable surface 16 may be contained inside of the cylinder. Conveyance of web 12 through machine 10 may be effected by manually pulling a leading edge of the web from roll 14 and laying it over movable surface/cylinder 16, then causing the cylinder to rotate via the internal drive mechanism.

By proper selection of material(s) for the movable surface 16, the combination of the gravitational force exerted by the web 12 on movable surface 16 and the frictional force between the web 12 and movable surface 16 is sufficient to allow the movable surface to convey the web, e.g., as the cylinder rotates. In this manner, additional conveyance machinery, such as a counter-rotating nip roller or conveyor belt as has been conventionally required, are not necessary in accordance with the present invention. As a result, the present machine is less complex and less expensive than conventional web-severing machines.

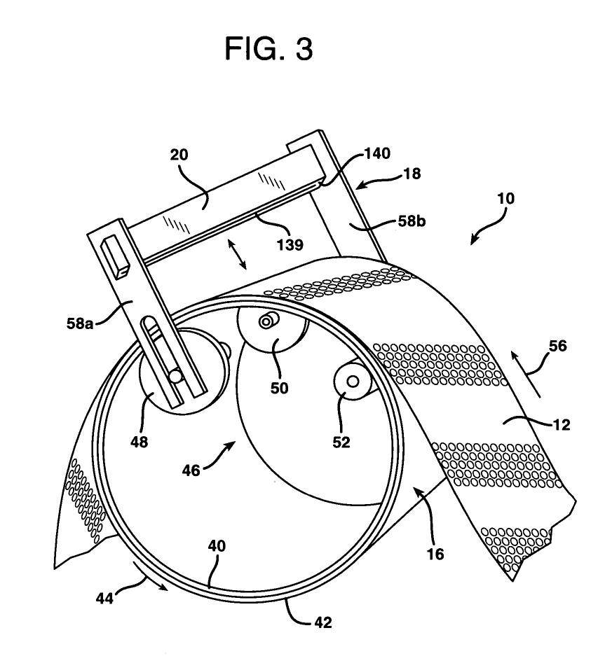

In the embodiment shown in FIGS. 1-2, a pair of end caps 30a, b may be included to cover the ends of the cylinder/movable surface 16. In addition, a bridge 32, which may be attached to or integral with end caps 30a, b, may be included to cover the severing mechanism 18 (FIG. 3). Severing mechanism is not shown in FIGS. 1-2 because it is covered by the end caps 30a, b and bridge 32. Conveniently, a control panel 34 may be disposed on the bridge 32, which allows the operator of machine 10 to select the length and number of cushioning sheets 36 desired. Alternatively, a foot or hand switch (not shown) may be used by the operator to produce either pre-selected or random lengths of cushioning sheet.

A bin 38 may be employed as shown to collect the cut sheets 36 as they are produced. Alternatively, machine 10 may be positioned over a work station or conveyor to dispense sheets 36 of cushioning material at their point of use, e.g., directly into shipping containers.

Referring now to FIGS. 3-5, the operation of the movable surface 16 and severing mechanism 18 will be described in further detail. Movable surface 16 may generally comprise a continuous surface that moves about a defined path. For example, movable surface 16 may have a cylindrical shape as shown. Alternatively, movable surface 16 may be a flexible belt driven and guided by internal drive/guide rollers, which define a desired path of travel for the belt and cause it to circulate about such path.

Regardless of the specific configuration, shape, or form assumed by the movable surface 16, it is advantageous that the movable surface comprise a material that 1) provides sufficient static and/or dynamic frictional force against the web to carry or otherwise propel the web in a desired direction upon movement of surface 16, and 2) has sufficient durability to withstand repeated contact thereagainst by the severing device 20. In one embodiment, the frictional force between the movable surface 16 and web 12 is sufficient for the surface 16 to convey the web based on only the weight of web 12 on surface 16. When severing device 20 employs a heating element such as a heatable wire, surface 16 ideally comprises a material with sufficient heat-resistance to withstand the temperatures generated by such heating element. Such heat-resistance is desirably sufficient to prevent the heating element from melting through the material when the severing device 20 urges web 12 against the movable surface.

Suitable materials for the portion of movable surface 16 that will be in direct contact with web 12 may be selected from the family of materials known as “elastomers,” particularly thermoplastic elastomers, which are also known as elastic polymers. Non-limiting examples of such elastomeric materials include:
acrylonitrile/chloroprene copolymer,
acrylonitrile/isoprene copolymer,
butadiene/acrylonitrile copolymer,
chlorinated polyethylene,
chlorosulfonated polyethylene,
ethylene ether polysulfide,
ethylene polysulfide,
ethylene/propylene copolymer,
ethylene/propylene/diene terpolymer (e.g., EPDM),
fluoroelastomer,
fluorosilicone,
hexafluoropropylene/vinylidene fluoride copolymer,
isobutene/isoprene copolymer,
organopolysiloxane,
acrylic ester/butadiene copolymer,
polybutadiene,
polychloroprene,
polyepichlorohydrin,
polyisobutene,
polyisoprene (natural or synthetic),
polyurethane (polyester),
polyurethane (polyether),
polyurethane (polyether and polyester),
polyethylene-butyl graft copolymer,
silicone polymers, particularly vulcanized silicone rubber, which may optionally be reinforced with inorganic fillers and/or fibers, and
styrenic copolymers (such as styrene/butadiene copolymer, stryene/chloroprene copolymer, and also styrenic block copolymers, such as SBS, SIS, and SEBS).

In the embodiment shown in FIGS. 3-5, movable surface 16 may comprise a cylindrical substrate 40. Substrate 40 may be formed from any suitable rigid or semi-rigid material, including metal, e.g., aluminum, steel, various alloys, etc.; plastic, e.g., polyvinyl chloride, polypropylene, polycarbonate, etc.; ceramics; etc.

Coated or otherwise disposed on substrate 40 may be a contact surface 42, which may comprise any of the elastomeric materials described above, or blends thereof. Advantageously, the particular elastomeric material selected may be matched with the web to be conveyed such that a desired level of friction between the contact surface 42 and web 12 is achieved in order to provide conveyance by the movable surface/cylinder 16. Ideally, material selection for contact surface 42 will also take into account the particular severing device 20 to be employed, with heated severing devices necessitating a relatively high degree of heat-resistance, for example, and cutting devices requiring a relatively high degree of impact toughness.

As an example, when conveying a web of inflated Bubble Wrap® cushioning material, having a width of 16 inches and comprising primarily polyethylene, contact surface 42 comprised a coating of Silastic® M RTV silicone rubber (from Dow Corning), having a Shore A durometer hardness of 59 and a thickness of ⅛ inch. Such a coating was manufactured ed by Precision Elastomers, Inc. of Ipswich, MA, which applied the coating in liquid form to substrate 40, whereupon it cured into a solid coating in adherence with the substrate. Cylindrical substrate 40 was made from aluminum tubing having an inner diameter 9.5 inches, a wall thickness of ⅛ inch, and a length of 16 inches.

In FIG. 3, the movable surface/cylinder 16 is driven in the direction shown by arrow 44. Conveniently, an internal drive mechanism 46 may be employed, which may include a motorized drive wheel 48 that is near one edge of the cylindrical substrate 40, and a driven wheel 50 near the opposite edge as shown. Idle rollers 52 may be also be included to stabilize the cylinder. In some embodiments, the weight of the movable surface/cylinder 16 resting on the drive wheels 48, 50 and rollers 52 provides the necessary traction to drive the cylinder and advance the web 12.

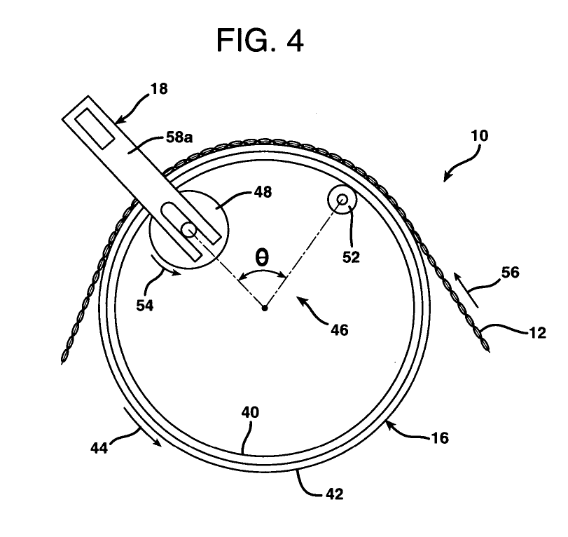

Referring to FIG. 4, it may be seen that drive wheel 48, and also driven wheel 50 (not shown in FIG. 4), rotates in the direction shown at 54. In the present embodiment, drive/driven wheels 48, 50 generate sufficient traction with the inner surface cylindrical substrate 40 to rotatably drive the movable surface/cylinder 16, which advances the web 12. Idle rollers 52 may be provided to support the cylinder. The wheels 48, 50 and rollers 52 may be spaced apart at an angle “θ” ranging from about 90 to about 160 degrees, such as about 100 to about 140 degrees, from the axial centerline of the cylinder. For example, an angle “θ” of about of 120° has been found to provide a beneficial combination of stability and traction, but other angles could work as well. Advantageously, since only two points of contact are used to support the cylindrical movable surface 16, variations in roundness of cylindrical substrate 40 do not affect the drive operation.

Machine 10 in accordance with the present invention may generally operate in two primary modes:

1) a “conveyance mode,” wherein the movable surface 16 moves, e.g., rotates, to convey web 12 in a forward direction; and

2) a “severance mode,” wherein the severing mechanism severs web 12 into selected lengths.

FIGS. 3-4 show machine 10 in the conveyance mode, wherein the cylinder-shaped movable surface 16 is driven by drive mechanism 46 in the direction of arrow 44 to convey web 12 in the direction of arrow 56. In this mode, severing mechanism 18 is idle, with web 12 passing beneath severing device 20 as shown.

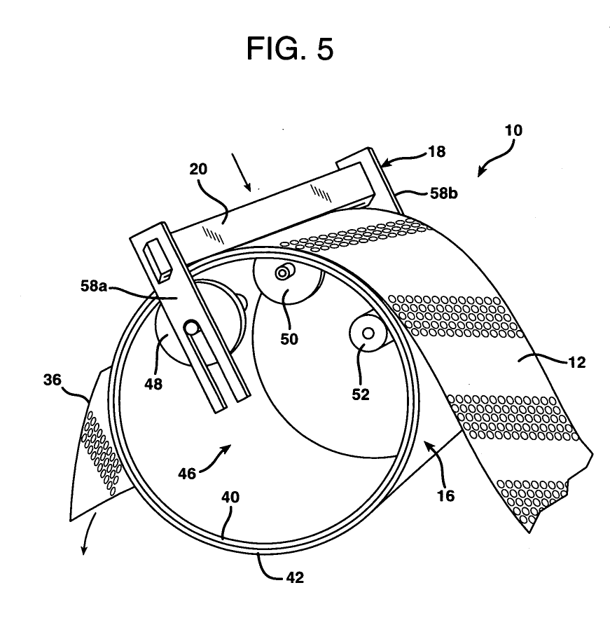

FIG. 5 shows machine 10 in the severance mode, wherein drive mechanism 46 has stopped driving movable surface 16, and severing mechanism 18 is effecting the severance of web 12. As shown, severing device 20 urges web 12 against movable surface 16 generally and, more particularly, against contact surface 42 thereof. Severing mechanism may include a pair of connector arms 58a, b, which are attached to severing device 20. The connector arms 58a, b may, in turn, be linked to a drive mechanism (not shown), which may be the same as or separate from that which drives the rotation of movable surface 16 (described in further detail below).

Severing device 20 may move into pinching relationship with movable surface 16 (to effect severance of web 12) in a direction that is substantially perpendicular to surface 16. Further, severing device 20 may move in a substantially linear path of travel as shown. These features are particularly advantageous when web 12 comprises a gas-containing, cellular cushioning material, such as Bubble Wrap® cushioning material because a minimum number of gas-cells or bubbles are contacted by the severing device, thereby minimizing the number of gas-cells that are deflated by melting or cutting. In contrast, a severing device that moves into severing relationship in a pivotal or rotatable fashion would approach the web at a more acute angle, thereby adversely affecting all gas-cells in the path of approach and causing the deflation of more cells that would otherwise be necessary to effect severance of the web.

After the severing operation is complete and severed cushion 36 is separated from the rest of web 12, the severing device 20 returns to its starting position as shown in FIGS. 3-4, whereupon machine 10 may revert to the conveyance mode to move more of web 12 through the machine.

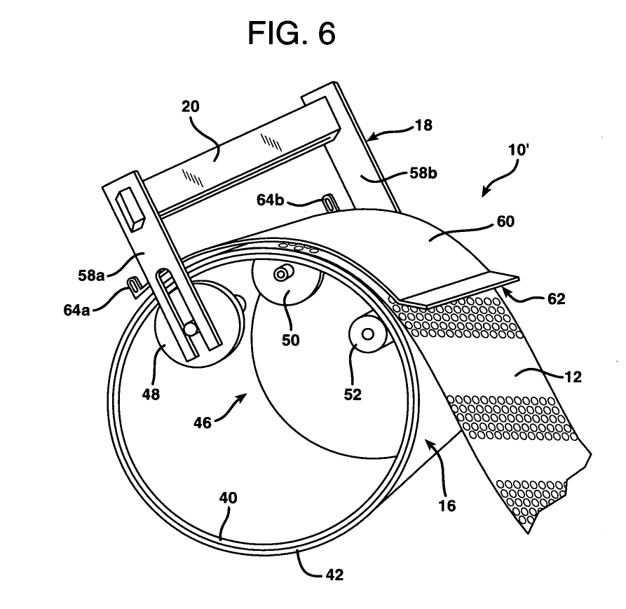

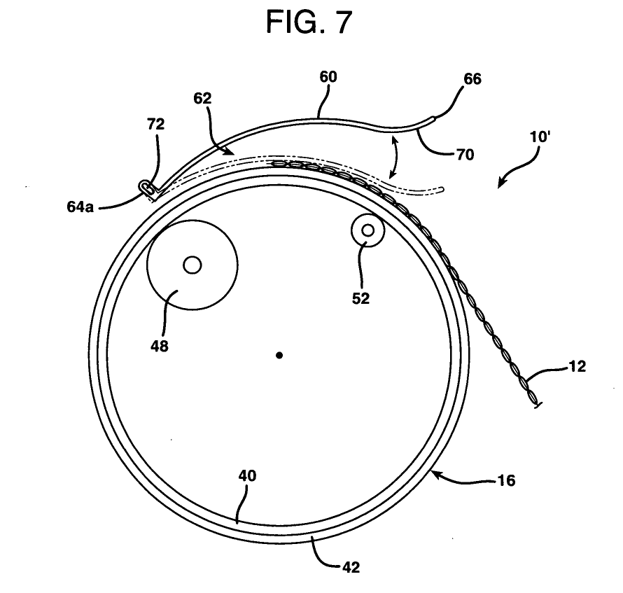

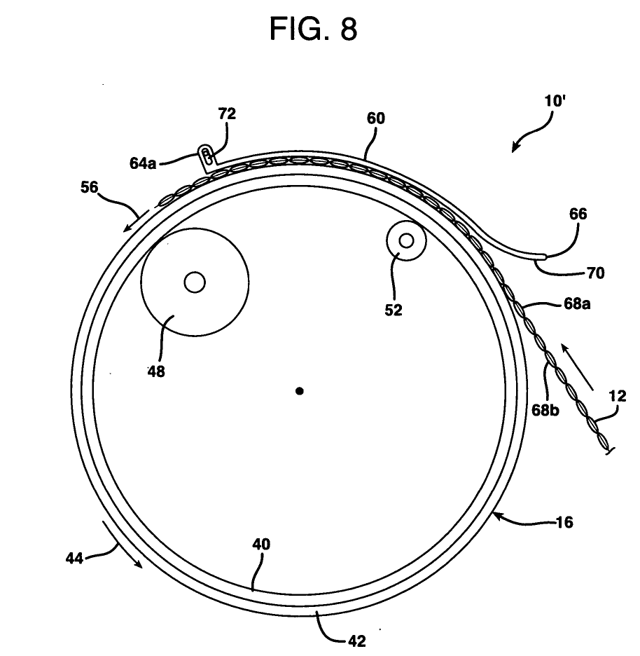

Referring now to FIGS. 6-9, an alternative embodiment of the invention will be described, wherein like components are referenced by like numbers. This embodiment is similar to the embodiment illustrated in FIGS. 3-5, except that the machine, designated 10′, includes a guide member 60 adjacent movable surface 16 to define a path 62 for movement of web 12 between the movable surface and guide member 60. Guide member 60 may be attached to end caps 30a, b (see, FIG. 1) via slotted mounting tabs 64a, b. In this manner, the guide member 60 is free to pivot about the mounting tabs 64a, b, as well as translate vertically in the slots, to facilitate loading of web 12 onto machine 10′. As shown in FIG. 7, the leading edge 66 of guide member 60 may be raised so that web 12 can be placed on movable surface 16 without interference from the guide member, e.g., when loading a new web on machine 10′. Guide member 60 is then lowered to the position shown in FIG. 8, whereupon web conveyance may begin.

Guide member 60 may advantageously provide a measure of safety, by reducing the likelihood that an operator's hand will come in contact with the severing mechanism 18. In addition, particularly when severing device 20 employs a heated element to effect severance, the guide member facilitates the return of the severing device 20 to its starting position above the web, in the event that a portion of the web melt-bonds or otherwise adheres to the severing device.

Inclusion of guide member 60 may also be advantageous when the combination of the gravitational force exerted by the web 12 on movable surface 16 and the frictional force between the web 12 and movable surface 16 is insufficient to allow the movable surface to convey the web. In this instance, guide member 60 may be positioned relative to movable surface 16 such that it is in sliding contact with web 12 to facilitate the creation of additional traction between the web and the movable surface. More specifically, with reference to FIG. 8, web 12 has upper and lower surfaces 68a, b, respectively, wherein lower surface 68b is in contact with movable surface 16 and upper surface 68a may be in sliding contact with guide member 60 as shown. That is, the materials from which the guide member and movable surface are constructed are preferably selected such that the frictional force between lower surface 68b and movable surface 16 is greater than the frictional force between upper surface 68a and guide member 60. In this manner, web 12 moves with movable surface 16, but slides against/past guide member 60.

In some embodiments of the invention, the weight of the guide member resting on upper surface 68a of web 12 keeps the web in contact with movable surface 16. This, in conjunction with the frictional force between the movable surface 16 and web 12, insures that the web moves forward at the speed of the movable surface as it moves, e.g., rotates. In other embodiments, guide member 60 may exert additional force, i.e., a force that is greater than just the weight of the guide member, against the upper surface 68a of the web 12. This may be accomplished in any suitable manner, e.g., by adding extra weight to the guide member, via spring tension or compression, by pulling or pushing on the guide member with actuators (e.g., pistons) that are powered pneumatically, hydraulically, electromagnetically, etc.

As with the embodiments of the invention discussed above that do not employ a guide member, the use of a guide member still provides web conveyance without the need for a separate drive mechanism, such as a drive belt or nip roller in driving contact with upper web surface 68a. Thus, guide member 60 is preferably a relatively simple device with no moving web-drive components. The material and size of the guide member is desirably chosen to provide enough contact force for consistent drive, without adding undue friction between the guide member and the web. Preferred materials are those having a relatively low coefficient of friction, such as metals or crystalline plastics. For example, when using a cylindrical movable surface as described above, guide member 60 may comprise acrylic plastic having a thickness of ⅛ inch and a length such that it covers approximately 100° of the circumference of the cylinder. A curved or upwardly-angled section 70 near leading edge 66 may be provided to prevent the web from getting caught on the leading edge as the web enters path 62. This may be particularly advantageous when web 12 comprises bubble-containing cushioning material as shown.

Also when web 12 comprises bubble-containing cushioning material, slotted mounting tabs 64a, b may have elongated slots 72 that allow for vertical movement of the guide member. This allows for variations in the height of web 12, so that the guide member may continue to ‘float’ on top of the web as different heights are encountered.

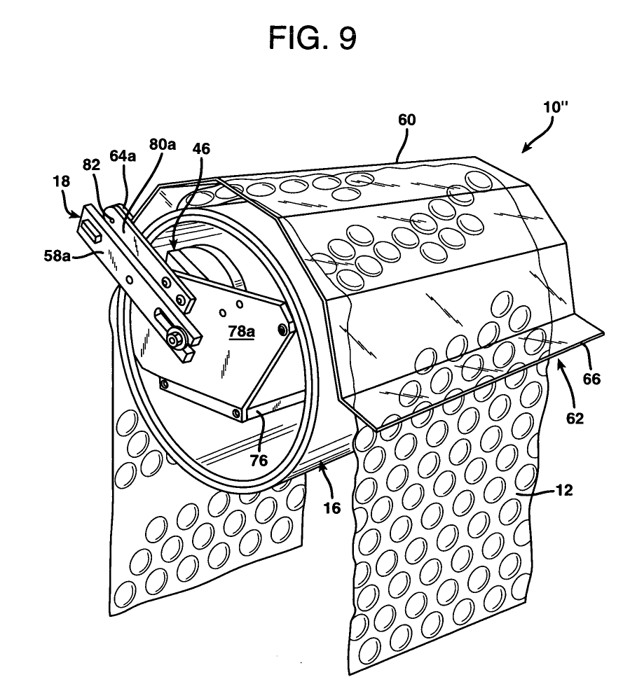

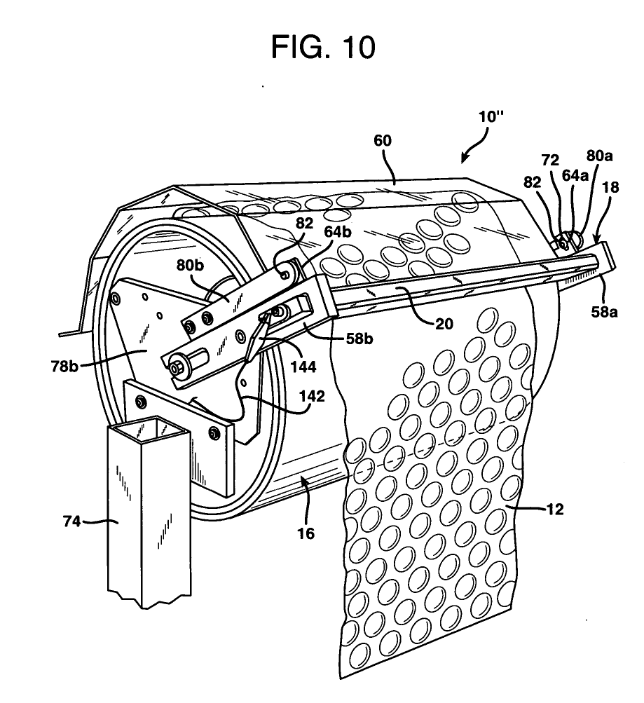

Referring now to FIGS. 9-10, a working embodiment of a machine in accordance with the present invention, designated 10″, will be described, wherein like components are referenced by like numbers. Like machine 10′, machine 10″ may include a guide member 60 as described above. Machine 10″ further includes an upstanding support frame 74, which may or may not include means to support a supply roll for web 12. Support frame 74 is attached to base plate 76, to which are attached a pair of end plates 78a, b at opposing ends of the base plate 76. Severing mechanism 18, drive mechanism 46, and guide member 60 are supported by the end plates 78a, b, with movable surface 16 being cylindrical-shaped and supported by the drive mechanism as described above. Support arms 80a, b extend from respective end plates 78a, b. A pin 82 is mounted at the distal end of each arm 80a, b. Guide member 60 is pivotally attached to the support arms 80a, b via pins 82, which extend through slots 72 in each of the respective mounting tabs 64a, b. In this embodiment, guide member 60 is in sliding contact with web 12.

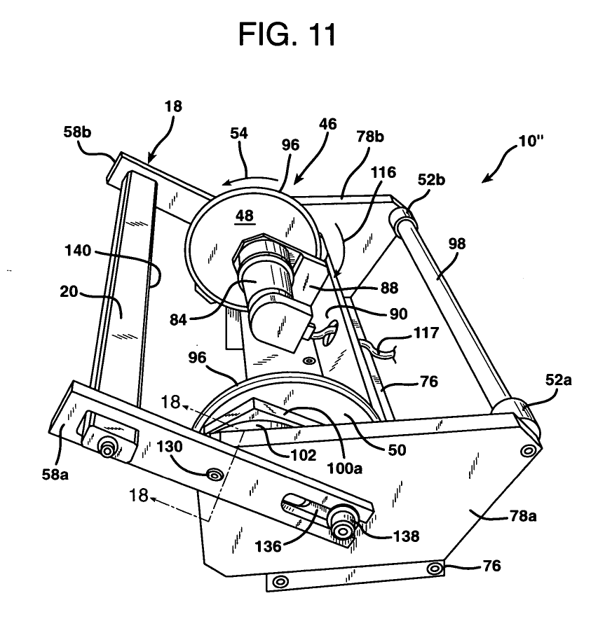

Referring now to FIGS. 11-18, severing mechanism 18 and drive mechanism 46 will be described in further detail. In those Figures, movable surface 16 and guide member 60 have been removed from machine 10″ in order to show the components of the severing and drive mechanisms 18 and 46. As with machine 10 described above in relation, e.g., to FIGS. 3-4, movable cylindrical surface 16 rests on drive wheel 48, driven wheel 50, and idle rollers 52a, b.

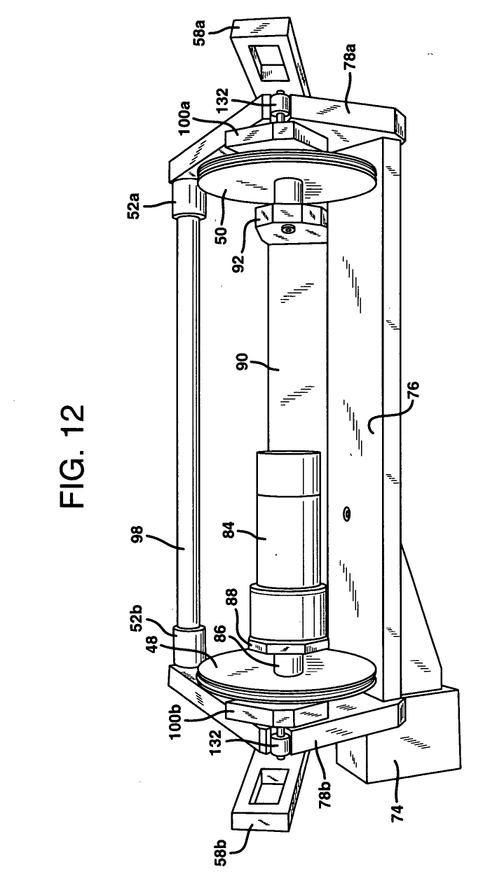

Referring specifically to FIGS. 11, 12 and 14 (in FIG. 12, severing device 20 has been removed from machine 10″ for clarity), drive mechanism 46 may include a drive source, such as motor 84, to which drive wheel 48 is attached, e.g., directly via drive shaft 86 as shown. Motor 84 may be a gear motor or other drive source. The specific type of motor may be selected based on its speed and torque, depending on the specific configuration of the machine. A suitable example for some embodiments of the invention is a 24 volt, DC-powered Pittman gear motor with an encoder, part # GM9236S027. Motor 84 may be attached via bracket 88 to link arm 90. Driven wheel 50 may be rotatably mounted on shaft 94. Shaft 94 is fixed at one end to bracket 92 and rotatably connected at the opposing end to end plate 78a. Like bracket 88, bracket 92 is also attached to link arm 90.

Drive/driven wheels 48/50 may be manufactured of metal, e.g., aluminum, or other suitable material. If desired, e.g., to provide improved traction against the inner surface of movable surface 16 (e.g., to cylindrical substrate 40) and/or to reduce the operating noise of machine 10″, a resilient material may be included around the circumference of each wheel. For example, a rubber O-ring 96 may be included around the circumference of each wheel as shown (o-ring 96 omitted from FIG. 12, to show groove in periphery of each wheel 48, 50 in which o-rings may be retained).

Idle rollers 52 may be provided as a pair 52a, b, which may be rotatably mounted to idle shaft 98. Idle shaft 98 is attached to end plates 78a, b as shown. Rollers 52a, b may each comprise a metallic material, which is rubber-coated for quiet operation when rolling inside the cylinder/movable surface 16.

In some embodiments of the invention, drive mechanism 46 produces both of the following actions:

a) the movement of movable surface 16 to convey web 12, and

b) the movement of severing device 20 against movable surface 16 to sever web 12 (i.e., when the web is positioned between the severing device 20 and movable surface 16).

In those embodiments, therefore, only a single drive source, e.g., motor 84, is needed to perform both actions. This may be accomplished in accordance with the present invention when the drive source for drive mechanism 46 is a reversible drive source, which is capable of producing a driving force in a first direction and in an opposing second direction. For example, motor 84 may be a reversible motor, e.g., a reversible DC motor, which may produce a driving force at drive shaft 86 in two opposing directions, e.g., clockwise and counterclockwise, by reversing the polarity of the current supplied to the motor. The above-described DC-powered gear motor, for instance, may be driven in a forward or a reverse direction.

Drive mechanism 46 may also include a drive transmission that interconnects movable surface 16 and severing mechanism 18 to the reversible drive source, e.g., motor 84, such that

a) motor 84 or other drive source causes movable surface 16 to move when the motor produces a driving force in the first direction, and

b) motor 84 causes severing device 20 to urge web 12 against movable surface 16 when the motor produces a driving force in the opposing, second direction.

As will be described in more detail immediately below, the reversible drive source, e.g., motor 84, may be movably, e.g., pivotally, supported by the drive transmission for movable adjustment of drive mechanism 46 between

a) the “conveyance mode,” which may occur when motor 84 produces a driving force in the first direction, and

b) the “severance mode,” when motor 84 produces a driving force in the second direction.

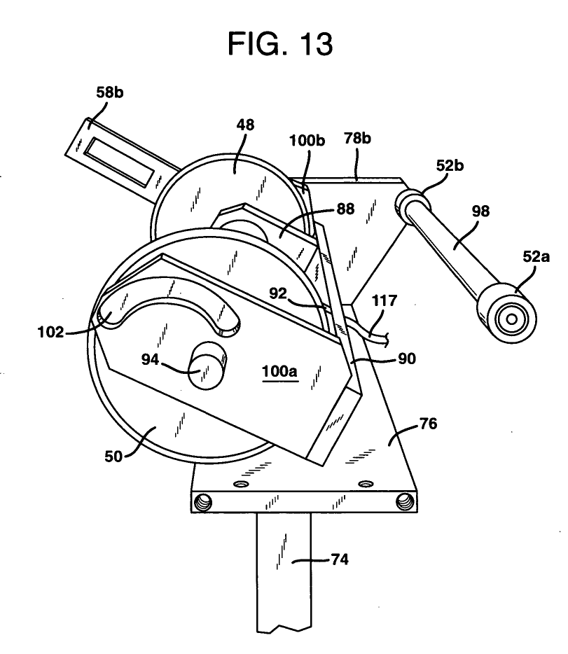

FIG. 13 shows an end view of machine 10″ with end plate 78a and connector arm 58a removed. Attached to each end of link arm 90 is a cam plate 100a and 100b. Each cam plate 100a, b has an eccentric slot 102 that functions as a cam lobe to move the severing device 20 as will become evident below.

FIG. 14 is a partial cross-sectional view of drive mechanism 46. As shown in this view, drive mechanism 46 is suspended between end plates 78a, b. Motor 84 is mounted to bracket 88, through which drive shaft 86 passes. Drive shaft 86 is secured to drive wheel 48 at the axis thereof such that the drive wheel rotates as a unit with the drive shaft. Drive wheel 48 may include an elongated shaft 104, which extends axially from the drive wheel in opposition to drive shaft 86. Shaft 104 passes through a clearance 106 in cam plate 100b, and into a bearing 108 in end plate 78b. Bearing 108 may advantageously be a one-way clutch bearing, such as a model RC-161210-FS one-way clutch bearing, which is commercially available from The Timken Company. This type of bearing allows the elongated shaft 104 and drive wheel 48 to rotate in one direction, but does not allow the shaft/drive wheel to rotate in the opposite direction. It can be installed so that drive wheel 48 can rotate only in the direction that the movable surface 16 is to be driven.

On the opposite end of drive mechanism 46, driven wheel 50 rides on a bearing 110, through which the driven wheel shaft 94 passes and mounts securely to the driven wheel bracket 92. The driven wheel 50 can rotate freely about shaft 94. Shaft 94 passes through a clearance 112 in cam plate 100a and into a bearing 114 in end plate 78a. Bearing 114 may be a plain bearing that allows shaft 94 to rotate in either direction. Thus, driven wheel shaft 94 may rotate with any rotation of bracket 92, but rotates against (relative to) end plate 78a via bearing 114. As may be appreciated, drive mechanism 46 is thus rotatably suspended by bearings 108 and 114 in end caps 78a, b.

With respect to the foregoing description of drive mechanism 46, motor 84 serves as the drive source while the other components to which motor 84 is operably and physically connected serve as a drive transmission to enable the drive mechanism to function in both the conveyance mode and in the severance mode.

In some embodiments, drive mechanism 46 may alternate between the conveyance mode and the severance mode. FIG. 11 illustrates the drive mechanism in the conveyance mode, in which motor 84 produces a driving force in a first direction 54, which results in drive wheel 48 also rotating in such first direction, which is counter-clockwise as shown. As explained above, such rotation of drive wheel 48 causes movable surface 16 to move, e.g., rotate, when drive wheel 48 is in contact with the inner surface of the movable surface. The driving force produced by motor 84 in this manner creates an equal counter-rotational force on the drive transmission, rotating it in a clockwise direction 116 until it hits a hard stop. In this embodiment, link arm 90 comes into contact with base plate 76 (see, also, FIGS. 12-13), which stops the drive transmission from rotating further in the clockwise direction 116. As a result, only the drive wheel 48 rotates, which causes the rotation of movable surface 16 to advance the web 12.

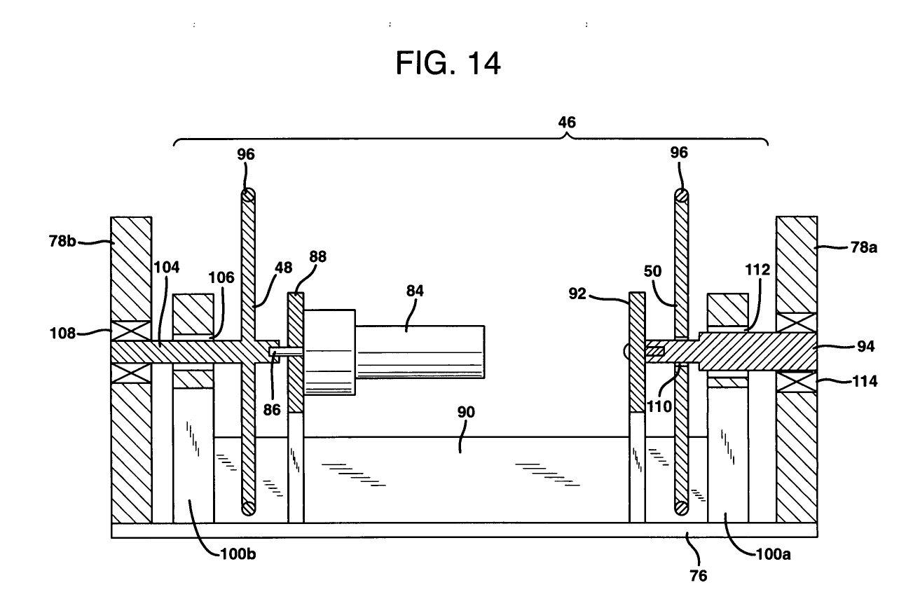

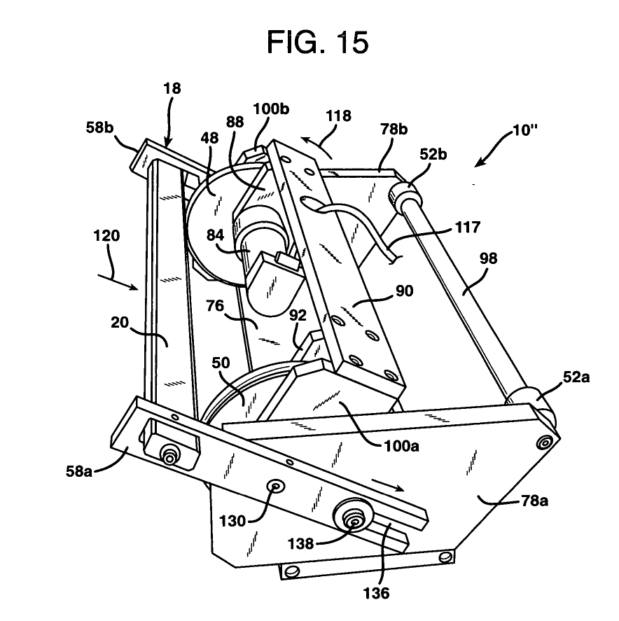

Once the desired amount of web 12 has been dispensed, drive mechanism 46 may be movably adjusted to assume the severance mode. This may be accomplished by reversing the polarity of the voltage to motor 84 with an appropriate switching device (not shown), e.g., a circuit board or PLC w/switching relays, via power-supply wires 117. This reversal of the voltage polarity causes motor 84 to produce a driving force in a second direction, which is different from, e.g., opposite to, first direction 54. For example, while first direction 54 is counter-clockwise, the second, opposing direction may be clockwise. In this example, motor 84 thus attempts to rotate drive wheel 48 in the second, clockwise direction (i.e., opposite to that of direction 54), but the one-way clutch bearing 108 prevents the drive wheel from turning in that direction. The resultant counter-rotational force on drive mechanism 46 causes the drive transmission to rotate in a counter-clockwise direction 118 as shown in FIG. 15, such that link arm 90 rotates in direction 118 off of its resting position on base plate 76. As the counter-clockwise rotation of the drive transmission occurs, eccentric slots 102 in each of cam plates 100a, b rotate and cause the connector arms 58a, b and severing device 20 to move in a linear path of travel in direction 120 to urge web 12 against movable surface 16 to effect severance of the web. As shown, the total rotation of link arm 90 is approximately 90°, but any suitable degree of rotation may be employed depending, e.g., on the thickness of web 12, shape of eccentric slot 102, etc.

When severance is complete, the motor polarity may once again be reversed. When this occurs, the drive transmission rotates in clockwise direction 116 until link arm 90 makes contact with and stops against base plate 76, whereby drive mechanism 46 once again assumes the conveyance mode shown in FIG. 11 such that movable surface 16 may again convey web 12 as shown, e.g. in FIG. 3. Advantageously, the inertia to begin the movement of movable surface 16 may be greater than the force needed to return severing device 20 to its outward position (FIG. 11). This insures that the drive mechanism 46, and therefore the severing mechanism 18, is fully returned to the conveyance mode before the movable surface 16 begins to move, e.g., rotate.

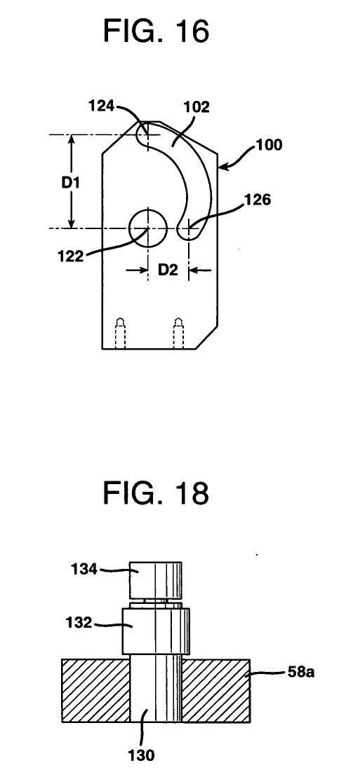

FIG. 16 shows one of cam plates 100a, b (they are identical in the present embodiment) that is attached to link arm 90. This plate rotates within drive mechanism 46 as previously described, said rotation taking place about pivot point 122. “D1” represents the distance from pivot point 122 to far end 124 of slot 102. “D2” represents the distance from pivot point 122 to near end 126 of slot 102. The difference between distances D1 and D2 is the linear distance that severing device 20 travels as it moves from its outward position as shown in FIG. 11 (conveyance mode) to its web-contact position as shown in FIG. 15 (severance mode). For example, when web 12 is a bubble-containing cushioning material, e.g., Bubble Wrap® cushioning material, a linear distance D1-D2 of about 1.25 inches is suitable. Such distance may be modified as necessary to suit the particular end-use application, based on, e.g., the thickness of the web.

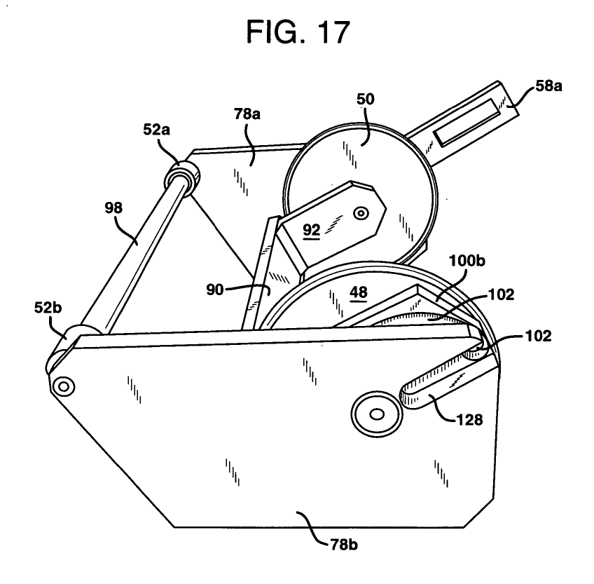

FIG. 17 shows machine 10″ with connector arm 58b removed from end-plate 78b. Linear slot 128 in end plate 78b, and an identical slot 128 in end plate 78a (not shown), guide the connector arms 58a,b so that they can move only in the direction of the slots 128 as the cam plates 100a, b rotate. Cam plate 100b and its eccentric slot 102 are visible in FIG. 17.

FIG. 18 is a partial cross sectional view of connector arm 58a taken along lines 18-18 in FIG. 11. A cylindrical pin 130 is affixed to each connector arm 58a, b (only pin 130 in arm 58a is shown). Pins 130 extend from each connector arm 58a, b in a direction generally inwards into machine 10″, i.e., towards each other. A bearing 132, e.g., a needle bearing, is placed on each pin 130 and allowed to rotate freely. A cam follower 134 may be screwed into the end of each pin 130 such that it also can rotate. When connector arms 58a, b are installed in machine 10″, bearing 132 rides in each linear slot 128 of end plates 78a, b to guide the connector arms along the direction of the slot 128 (see also FIG. 12). Similarly, cam follower 134 rides in each eccentric slot 102 of cam plates 100a, b, causing connector arms 58a, b to move in the direction of slots 128 as the cam plates rotate.

Referring back to FIGS. 11 and 15, an additional guide slot 136 in each connector arm 58a, b and corresponding stationary pin 138 in each end plate 78a, b may be included to prevent the connector arms 58a, b from rotating about the cylindrical pin 130 so that the entire severing mechanism 18 translates linearly, e.g., in direction 120, as shown in FIG. 15. As with any cam-operated system, the shape and position of the cam slots, e.g., eccentric slots 102, may be modified as necessary to adjust the speed and force of severing device 20 along its travel.

While drive mechanism 46 has been described above in connection with a specific embodiment in accordance with the claimed invention, many other configurations are possible. In order to minimize the space occupied by the machine, in any such alternative configuration, movable surface 16 will desirably comprise a continuous surface that moves about a defined path, with the drive mechanism positioned interiorly of said path. In a particularly space-saving configuration, the movable surface is in the form of a rotatable cylinder as illustrated in the drawings, and the drive mechanism is positioned inside of the cylinder such that the cylinder rotates about the drive mechanism as also shown in the drawings. Moreover, although advantageous from the standpoint of cost and simplicity, it is not a requirement of the present invention that only one motor be employed to operate by the movable surface and severing mechanism. Instead, these devices may be operated by separate power sources, e.g., one motor dedicated to operation of the movable surface and another motor dedicated to operation of the severing mechanism.

Severing device 20 may comprise any conventional device for severing a web of material, including a heating element such as one or more wires, knives, bands, or other electrically-heatable material; a cutting element such as a guillotine-type knife, a rolling, swinging or translating blade, a serrated blade; etc. In the presently-illustrated embodiment, severing device 20 comprises a heating element 139 capable of reaching a temperature sufficient to sever web 12 (FIG. 3). Such a heating element may be a resistance wire as shown, which may be positioned on the front or contact edge 140 of severing device 20. Such a wire may be spring-loaded to allow for expansion when the wire is heated. Electrical current may be supplied to wire 139, e.g., via electrical cord 142 and electrical connector 144 (FIG. 10). The wire may have any desired thickness and be made from any suitable material to achieve a desired heating rate and final temperature for the web-type used in the end-use application. For example, when web 12 is a bubble-containing cushioning material, e.g., Bubble Wrap® cushioning material, the wire may be a nickel-chromium alloy material approximately 0.015 inch in diameter.

Advantageously, movable surface 16 is employed not only as a conveyance surface but also as a surface against which severance device 20 urges web 12 during the severance operation. This greatly simplifies and reduces the number of required components of the web-severing machine, thereby minimizing cost and improving reliability. A potential downside of using movable surface 16 in such a dual-function role is that repeated impact by a severance device, either a heating or cutting type, can rapidly degrade a surface that is soft and flexible enough to also convey a web. However, because movable surface 16 starts, stops, and is cut upon at random intervals, based on operator and/or automated control of machine 10 (or 10′, 10″, etc.), the impingements by severing device 20 are made at random locations on the surface, e.g., circumference, of movable surface 16. As a result, cuts are rarely made at the same location on surface 16, and it has therefore been found to possess a relatively high degree of longevity.

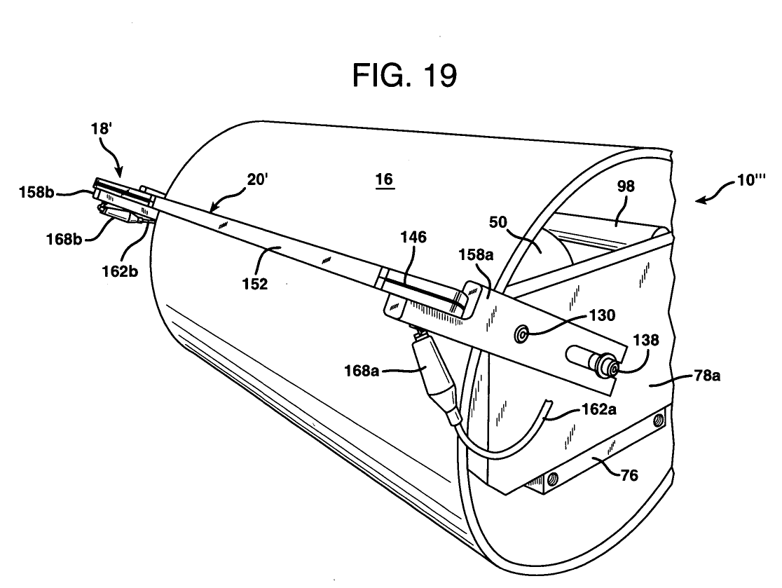

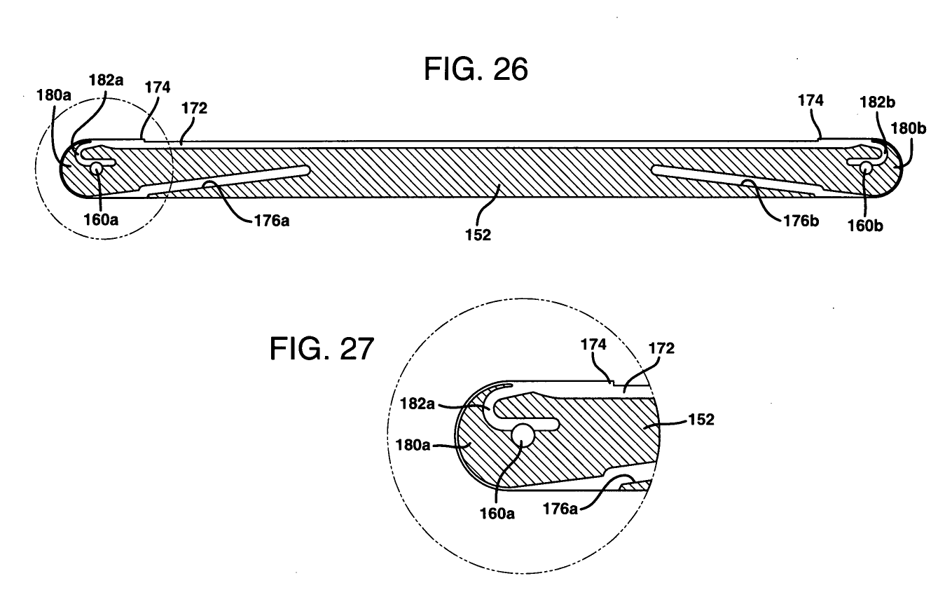

Referring now to FIGS. 19-27, an alternative severing device will be described. FIG. 19 shows a machine 10′″ in accordance with the present invention. Machine 10′″ is similar to machine 10″ as described above, except that it employs an alternative severing mechanism, designated as 18′, which, in turn, includes alternative severing device 20′.

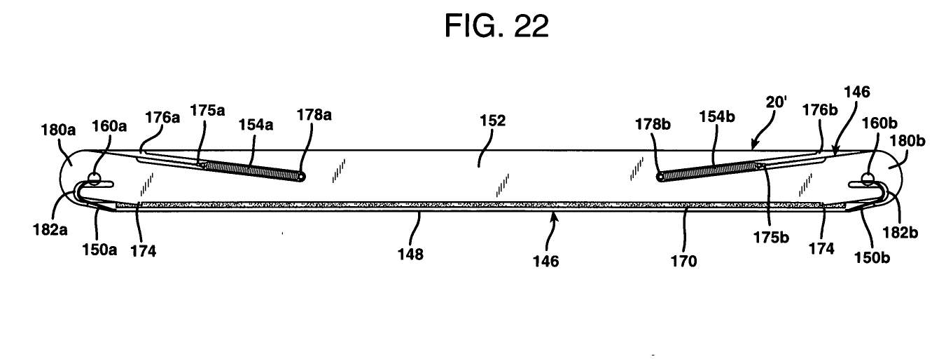

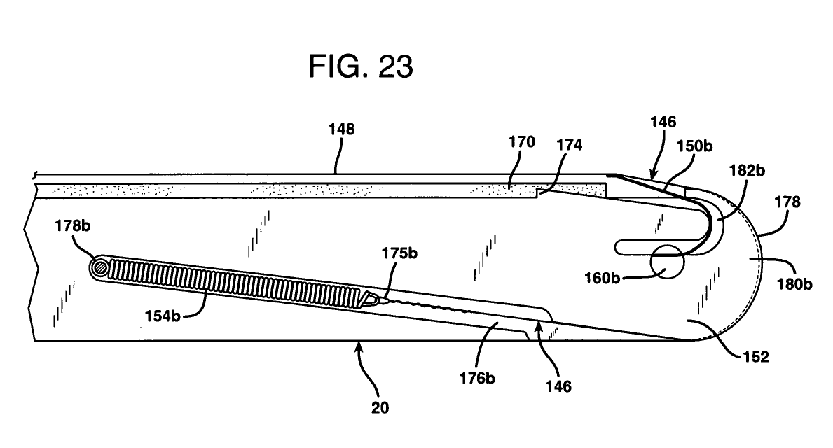

As illustrated in FIGS. 22-23, severing device 20′ includes a heating element 146 capable of reaching a temperature sufficient to sever a web, e.g., web 12, when electrical current flows therethrough. Severing device 20′ also includes two electrical nodes 150a, b that are connectable with a source of electricity and in electrical communication with heating element 146. Additional nodes may be included if necessary or desired. As will be explained in further detail below, heating element 146 is configured such that only a contact portion 148 thereof makes contact with and effects severance of the web. Further, electrical nodes 150a, b are positioned relative to heating element 146 such that electrical current flows substantially only through contact portion 148 of heating element 146.

Severing device 20′ may also include a support member 152 to provide physical support for heating element 146. This may be advantageous when heating element 146 is in the form of a wire or band as shown. As also shown, electrical nodes 150a, b may space the contact portion 148 of heating element 146 from support member 152. Alternatively or in addition, electrical nodes 150a, b may resiliently bias the contact portion 148 of heating element 146 away from support member 152.

In some embodiments, heating element 146 may be attached to support member 152 by a pair of tension-control units 154a, b. Such units, e.g., a pair of coil springs as shown, may be selected to maintain tension in heating element 146 over a predetermined temperature range at which the heating element is operated. For example, the material of construction, length, spring force, etc. of the coil springs may be selected based on the expansion and contraction of the heating element throughout the temperature range at which the heating element will be operated such that tension is maintained in the heating element over the entirety of such range, i.e., when the heating element is at full thermal contraction and also when it is at full thermal expansion.

As also shown, electrical nodes 150a, b may be positioned between tension-control units 154a, b. Thus, tension-control units 154a, b may be positioned at opposing ends of heating element 146 while electrical nodes 150a, b are positioned therebetween. In this manner, electrical current flows substantially only through contact portion 148, which lies between each of the electrical nodes 150a, b.

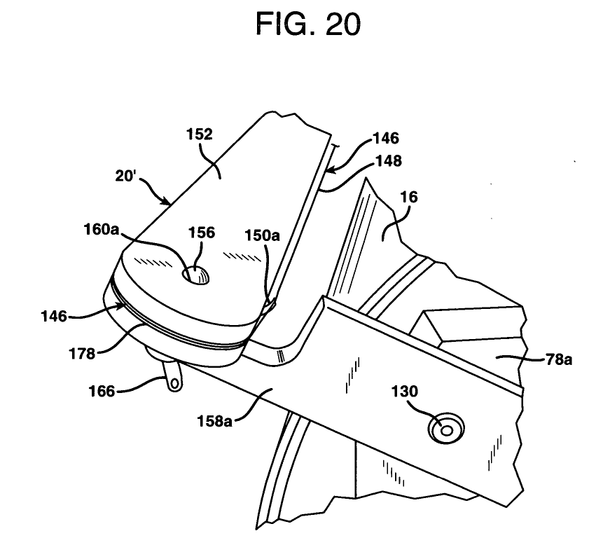

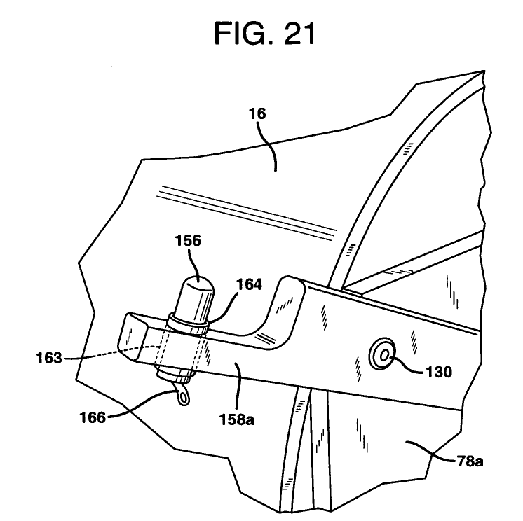

Referring now to FIGS. 19-21, support member 152 may be attached to connector arms 158a, b, which provide substantially the same function as connector arms 58a, b. Connector arms 158a, b may each include a conductive pin 156 as shown in FIG. 21 (pin 156 for connector arm 158b not shown). Conductive pins 156 may be made of an electrically conductive material, such as, e.g., brass, copper, etc. Support member 152 may include a pair of mounting orifices 160a, b (FIGS. 22-23), which are sized to allow insertion of conductive pins 156 therethrough. In this manner, the support member 152 may be detachably retained in a desired position on connector arms 158a, b as shown in FIGS. 19-20, i.e., by aligning each of orifices 160a, b with a respective pin 156 on each connector arm 158a, b and pushing support member 152 into position as shown.

In some embodiments, electricity to power heating element 146 is supplied through the conductive pins 156. In FIG. 19, a pair of wires 162a, b are connected to each of the pins 156, e.g., with wire 162a providing a flow of electric current to heating element 146 and wire 162b providing a flow of electric current out of the heating element. FIG. 20 is a close-up view of arm 158a with severing device 20′ attached to the arm. The top of conductive pin 156 is visible. FIG. 21 shows the same view, but with severing device 20′ removed. In order to ensure that electricity flows substantially only through heating element 146, conductive pins 156 may be electrically isolated from connector arms 158a, b. Alternatively, connector arms 158a, b may be constructed from a material having a low degree of electrical conductivity.

Electrical isolation of conductive pins 156 from connector arms 158a, b may be achieved by positioning a pair of non-conductive (e.g., plastic) shoulder washers 164 in an orifice 163 in each of the connector arms, and inserting pins 156 through the shoulder washers 164 as shown in FIG. 21. An electrical contact tab 166 may be attached to the bottom of each pin 156, e.g., via a screw, weld, or other means to electrically and physically attach the tab to the pin. Appropriate connectors 168a, b may be employed to connect wires 162a, b to the contact tabs 166 for each of the conductive pins 156 (FIG. 19).

Accordingly, heating element 146 may be energized, for example, by causing electrical current to pass from wire 162a and into contact tab 166 via connector 168a, whereupon the current flows through conductive pin 156 at orifice 160a, and into heating element 146 via electrical node 150a (described in further detail below). The current may exit heating element 146 at electrical node 150b, whereupon it flows through the pin 156 of connector arm 158b at orifice 160b, and into wire 162b via contact tab 166 and connector 168b.

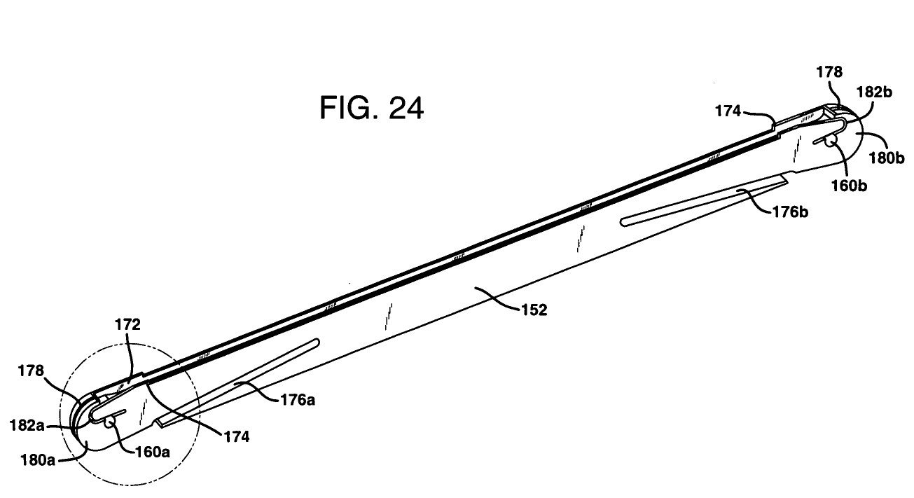

Referring collectively to FIGS. 22-27, further details of some embodiments of severing device 20′ will be described. For example, device 20′ may include a resilient backing pad 170 (FIGS. 22-23), which may be contained within longitudinal slot 172 in support member 152 (FIGS. 24-27). Backing pad 170 may be constructed of a material that is both resilient, e.g., compressible, and capable of withstanding the heat generated by heating element 146. Suitable materials include “elastomers,” particularly thermoplastic elastomers as described above. For example, expanded, i.e., foamed, silicone was found to be a suitable material for backing pad 170. When severing device 20′ urges a web to be severed against movable surface 16, backing pad 170 provides a resilient platform to urge the heating element 146 against the web and movable surface.

The firmness of pad 170 and amount of pad compression may be selected to provide a desired amount of force with which the heating element is urged against the web and movable surface. Maximum pad compression may be set by including a step 174 at each end of support member 152 (FIGS. 22-25). For example, as shown in FIG. 23, if the thickness of pad 170 is such that it extends out of slot 172 and beyond the maximum height of step 174, the pad, and therefore heating element 146, will continue to be compressed against the movable surface 16 until the pad and heating element are compressed down to the level of steps 174. At that point, the steps 174 will be in contact with the web and/or movable surface 16, and no further compression of pad 170 will occur because support member 152 will be prevented from moving any further toward the movable surface. Pad 170 may extend beyond steps 174 by any suitable amount, e.g., from about 0.5 to about 0.001 inch, to provide a desired amount of compression against the web and movable surface 16. For example, in one embodiment of the invention, the pad 170 may extend 0.050 inch above step 174.

As noted above, severing device may include tension-control units 154a, b, attached to the opposing ends 175a, b of heating element 146. As shown perhaps most clearly in FIG. 23, each tension-control unit 154a, b may take the form of a coil spring, which may reside in respective slots 176a, b on the underside of support member 152, i.e., the side of member 152 opposite to the side that is adjacent to contact portion 148 of heating element 146. For the embodiment illustrated in FIGS. 22-23, for example, a spring force of about 4 pounds may be employed for each of the coil spring-type tension-control units. A different tension may be employed as desired to accommodate different configurations, applications, heating element diameters, etc.

Within slots 176a, b, tension-control units 154a, b may be attached to support member 152 via pins 178a, b. When heating element 146 is in the form of a wire, the tension-control units may be attached to the ends 175a, b of the heating element by twisting the element upon itself at each end to form a loop, which engages with a hook, loop, or other attachment device on each of the units 154a, b as shown.

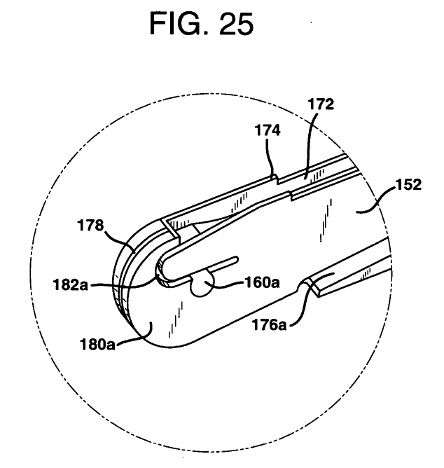

Each end 180a, b of support member 152 may include a groove 178, which retains the portions of heating element 146 that extend around the ends 180a, b of the support member (FIGS. 24-25). In some embodiments, then, the heating element may be wrapped around all of, or a portion of, the periphery of the support member. For example, starting at end 175a of heating element 146, the heating element may extend from its point of attachment to tension-control unit 154a in slot 176a, wrap around end 180a in groove 178, make contact with electrical node 150a, extend across contact portion 148, make contact with the opposing electrical node 150b on the other side of the contact portion 148, wrap around end 180b in groove 178, and extend into slot 176b in which end 175b is secured to tension-control unit 154b. As the heating element expands and contracts due to temperature changes, it may slide around the ends 180a, b of support member 152 in grooves 178. Support member 152, or at least ends 180a, b thereof, may therefore advantageously be constructed of a material that has a relatively low coefficient of friction, including various polymeric materials such as, nylon (e.g., a nylon/molybdenum disulfide blend), polyimide, acrylonitrile-butadiene-styrene (ABS) resins, polycarbonate, and blends of the foregoing. Ceramic materials may also be suitable.

As noted above, electrical nodes 150a, b may be configured to space the contact portion 148 of heating element 146 from support member 152. Alternatively or in addition, electrical nodes 150a, b may resiliently bias the contact portion 148 of heating element 146 away from support member 152. In some embodiments, electrical nodes 150a, b may take the form of ‘j-shaped’ leaf springs as shown in FIGS. 22-23, which may reside in j-shaped slots 182a, b in support member 152 (FIGS. 24-27). Such leaf springs may, for example, be made from spring steel, copper (e.g., berrylium-copper alloy), bronze (e.g., phosphor-bronze alloy), or other suitable metal, having a thickness of about 0.015 inch and a width of about 0.220 inch. Other sizes are, of course, fully within the scope of the present invention. The interior of slots 182a, b may be wider than the entrance to thereby capture the springs within the slots, but still allow movement of the springs within the slots.

The portion of the spring-type electrical nodes 150a, b in contact with heating element 146 may be biased outwards, i.e., away from support member 152, thereby holding the heating element at a predetermined distance away from the support member, e.g., away from resilient backing pad 170 as shown. In some embodiments, such spacing between the heating element and support member may be advantageous. For example, when web 12 is comprises a thermoplastic material, the heating element 146 may become coated with polymeric material from repeated contact with the web during severance, wherein molten polymer from the web solidifies on the heating element. Such polymeric residue may be conveniently removed from time to time by causing the heating element to effect a ‘burn-off’ cycle, in which the heating element is heated while severing device 20′ is in the conveyance mode, i.e., wherein the heating element is not in contact with a web or with movable surface 16. This causes the polymeric residue to vaporize off of the heating element. If the heating element is in contact with support member 152 during this process, much of the heat will be transferred to the support member, e.g., to pad 170, requiring excess heat to effectively remove the polymeric residue.

Another advantage of spacing the heating element from the support member is that the heating element can be heated more quickly than if it is in contact with the support member. This is because the support member acts as a heat sink when the heating element, particularly the contact portion thereof, is in direct contact with the support member. When the contact portion 148 is spaced from the support member as shown, very rapid heating of the contact portion is possible. For example, when the heating element comprises a nickel/chromium wire having a diameter of approximately 0.015 inch, the wire can be fully heated by the time it makes contact with the web by applying a 24 volt current across the wire just as the severing mechanism 18′ begins to move the severing device 20′ towards the web. The current can then be stopped just before the severing device 20′ is retracted such that the total current-flow time is 1−1.5 seconds/cycle. As can be appreciated, this relatively short period in which current flows is advantageous from the standpoint of both reduced energy usage/cost, and also reduced thermal fatigue on the heating element, thereby providing increased service life.

As can be seen in FIGS. 22-23, a portion of each of the electrical nodes/leaf springs 150a, b protrudes into respective mounting orifices 160a, b in support member 152. Both electrical nodes 150a, b may be electrically conductive. In this manner, when conductive pins 156 are inserted into the orifices 160a, b, electrical contact is made between each of the pins 156 and electrical nodes 150a, b. As noted above, the electrical nodes 150a, b are in electrical communication, e.g., contact, with heating element 146. In this embodiment, therefore, when severing mechanism 18′ is energized, electrical current flows only through the contact portion 148 of heating element 146, because such contact portion lies between the electrical nodes 150a, b. That is, current flows into one of the nodes 150a, b, through contact portion 148 of the heating element, and exits via the other electrical node. As a result, only the contact portion 148 of the heating element 146 is heated.

Advantageously, with this embodiment, the portions of the heating element 146 between electrical node 150a and tension-control unit 154a, and between electrical node 150b and tension-control unit 154b, including the tension-control units themselves, remain relatively cool, i.e., are not heated because substantially no electrical current flows through those portions. Thus, no precautions are necessary to keep these portions, nor the tension-control units 154a, b or any other components in contact therewith, from overheating. In general, it is desirable to minimize the amount of time that the heating element is maintained at a high temperature, e.g., a temperature high enough to sever the web, because heat is the primary cause of failure of the heating element (due to heat stress or heat fatigue). Stated somewhat differently, heating elements generally have a maximum amount of time at which they can be maintained at a given temperature before failure, with greater temperatures generally allowing less time before failure. Since the contact portion 148 can be heated quickly as noted above, and transfers its heat to the web 12 and/or movable surface 16, it stays at an elevated temperature for a relatively short duration. If the other portions of the heating element that do not contact with web were heated, such portions would either remain hot, and therefore fail prematurely, or transfer excessive heat to support member 152, which could damage or otherwise shorten the service life of the support member. Thus, inexpensive materials, e.g., plastics that do not have a high heat tolerance, may be used for support member 152.

In some embodiments, outward biasing of heating element 146 by electrical nodes 150a, b may be advantageous by reducing physical stress on the heating element as it makes contact with the web, i.e., by allowing the heating element to resiliently move towards the support member 152 as contact is made with the web. In other embodiments, the inclusion of pad 170 continues the resilient movement of the heating element into support member 152 until full contact is made, e.g., when the pad is compressed to the level of steps 174. As contact is made with the web, the leaf spring-type nodes 150a, b may flex inward into longitudinal slot 172 in the support member so that the final urging of the heating element against the web can be performed by the resilient pad. Advantageously, tension-control devices 154a, b take in the resultant slack in the heating element to maintain tension therein.

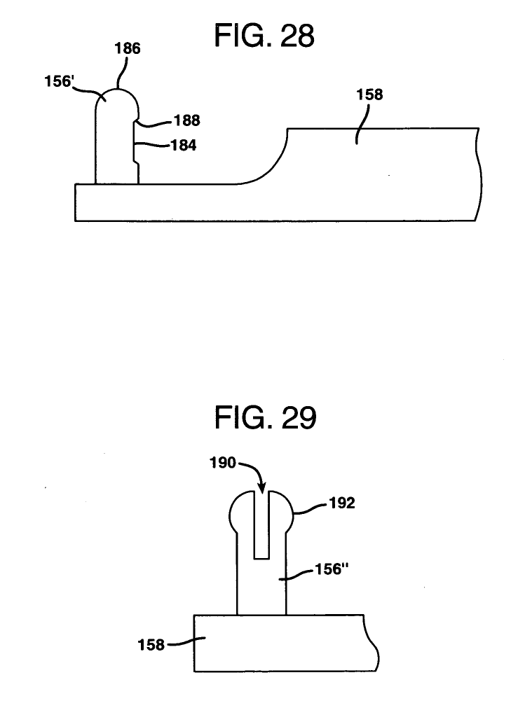

Referring now to FIG. 28, an alternative embodiment of conductive pin 156 will be described. Conductive pin 156′ has a cut out area 184. The top 186 of pin 156′ may be radiussed or chamfered so that when the mounting orifices 160 of support member 152 are pressed onto the pins, the electrical nodes 150, which extend into orifices 160, are moved out of the way. Once the pins 156′ have been fully inserted into orifices 160, the electrical nodes 150 may snap into the cut out area 184. In this manner, electrical nodes 150 (1) act as a latch that holds the support member in place on connector arms 158, and (2) make electrical contact with the pins 156′. Conveniently, the top 188 of cut out area 184 may be shaped with an angle that is chosen to allow the support member 152 to be readily removed from connector arms 158 by hand, e.g., for repair or replacement, but held firmly enough to keep it in place during operation.

Another alternative embodiment to conductive pin 156 is shown in FIG. 29, wherein pin 156″ includes a vertical slot 190, and a bulbous top 192. Top 192 has a diameter that is larger than the diameter of the mounting orifices 160 in the bar. As the orifices 160 are pressed over the larger diameter top 192, the vertical slot 190 allows the surfaces of the top 192 to flex inward so that it can be inserted through the orifices. Once the top 192 has passed through the orifices 160, it springs back open to hold the support member in place. The size of slot 190 and the diameter of the bulbous top 192 may be selected to provide a desired amount of firmness with which support member is held on connector arms 158.

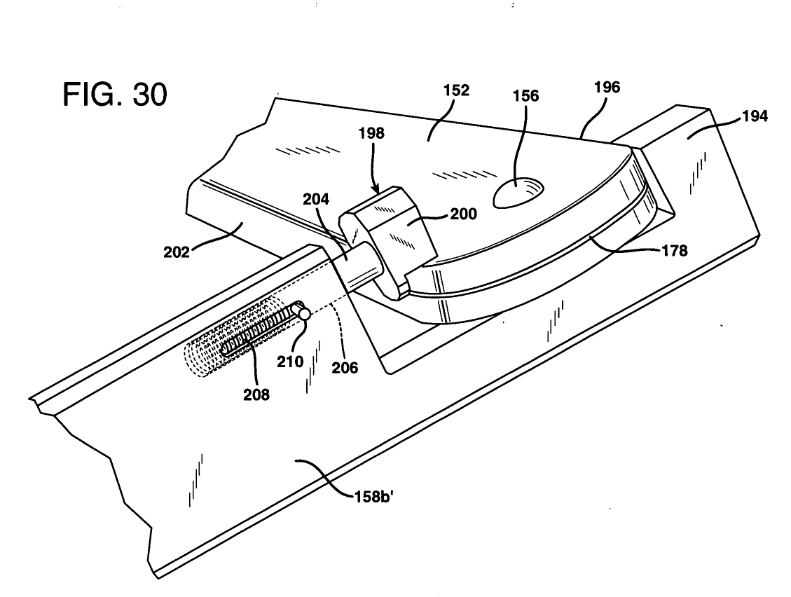

FIG. 30 illustrates a further alternative mechanism for securing the support member 152 to the connector arms, wherein support member 152 is attached to an alternative connector arm 158b′, which may be identical to an alternative connector arm 158a′ (not shown; the following description of alternative connector arm 158b′ applies equally to the opposing connector arm 158a′; also, heating element 146 is not shown in FIG. 30 for clarity). In this embodiment, connector arm 158b′ includes a raised section 194, which is in contact with the back side 196 of support member 152. In this manner, the contact force between the support member 152 and movable surface 16 is transmitted from the support member to the raised section 194 of connector arm 158b′ (as opposed to being transmitted solely to the conductive pins as in the embodiments described above with respect to connector arms 158).

Other embodiments may include a latching mechanism to secure the support member 152 to the connector arm. One such latching mechanism is shown in FIG. 30. Latch 198 has a contact section 200 that contacts the front 202 of support member 152 as shown, and urges it against raised section 194 of arm 158b′. A cylindrical section 204, attached to contact section 200, may be received by a cavity 206 in arm 158b′. A spring 208 contained in cavity 206 biases the latch 198 outward to effect the urging of support member 152 against raised section 194. A pin 210 may be included to prevent the latch 198 from coming out of cavity 206.

One of the advantages of severing device 20′ is that when replacement is necessary, it can be accomplished quickly and easily. An operator can keep a supply of the severing devices on hand, and machine downtime due to heating element failure is minimal. At a convenient time, the support members can be rebuilt with new heating elements, but the machine remains running.

A further alternative embodiment for the severing mechanism may be used when the web is a bubble-type cushioning material, wherein the severing mechanism seals the bubbles that are severed, thereby making partial bubbles at the edges of the resultant cushion. The advantage of this embodiment is that the entire cushion contains air-filled bubbles, rather than a row of deflated/severed bubbles at the severed edges of each cushion. In order to seal at least some of the gas inside the bubbles that are being severed, the web may be completely compressed against the movable surface by the severing device prior to energizing the heating element to effect severance. In order to seal the gas within the severed bubbles, both plies (upper and lower) of the bubble material must be in intimate contact before heating, or the heating element will burn through the upper ply and the gas will escape. To accomplish this, the severing device may compress an inflated bubble row, rather than burning through and deflating such bubbles during advancement of the severing device, as may occur when the heating element is at a temperature sufficient to sever the web when initial contact with the bubbles is made. Once the bubbles are sufficiently compressed to bring both plies of film together, the heating element may be energized to effect severance and sealing, thereby retaining the inflation gas in the resultant partial bubbles in either side of the sever/seal line created by the heating element.

Having now described various aspects of severing machines in accordance with the present invention, e.g., machines 10, 10′, 10″, and 10′″, the operation of such machines will now be described. The machines may be operated in a variety of ways. For instance, an electronic controller (not shown), e.g., in association with control panel 34 (FIG. 1), may be employed to manipulate all functions of the machines. This controller can be a printed circuit assembly, programmable logic controller (PLC) or other such device commonly used in machines of the type to which the present invention pertains. The machines may be fully and automatically controlled via the controller.

Alternatively, the machines may be controlled by the controller but with operator intervention, e.g., manually via a foot pedal, hand switch, or other manually-actuatable device. An operator may thus be able to select the length and number of cushions desired via control panel input to the controller, or may choose to depress a foot pedal or other means to manually select cushion lengths.

### EXAMPLES

The following examples describe three different operating sequences for machine 10″, which conveys and severs a web of Bubble Wrap® cushioning material: single mode, batch mode and manual mode.

### Example 1 (Single Mode)

In this mode of operation, machine 10″ makes one cut sheet of cushion having a length of 12 inches, which an operator selects via an electronic controller. Machine 10″ then performs three basic sub-operations:
1. Web Conveyance: Drive motor 84 is a 24 volt, DC-powered Pittman gear motor with an encoder, part # GM9236S027. It is operated in the forward direction 54 (FIG. 11), rotating the cylindrical movable surface 16 and feeding the web 12 until the correct length of web is advanced. The motor 84 includes an encoder, which produces electronic pulses as the internal motor shaft rotates. These pulses translate into web length conveyed as follows: The encoder associated with the above-described motor pulses 500 times per revolution of the internal motor coil. The motor is geared to have a drive ratio of 65.5:1, for a total of 32,750 pulses per revolution of drive shaft 86 and drive wheel 48. In this example, drive wheel 48 has a 5″ diameter, therefore a circumference of 15.7 inches, which produces 2086 pulses per linear inch of movement of the inner surface of movable surface 16. Since the cylindrical movable surface 16 is driven from the inside, with the web being conveyed along the outside, the distance must be corrected by the difference inner diameter (ID) and outer diameter (OD) of the cylindrical movable surface 16. In this example, the cylinder 16 has an ID of 9.5 inches and an OD of 10 inches. Accordingly, the encoder produces 1981 pulses per inch of web travel on the outside of movable surface 16. Since a 12 inch sheet has been selected by the operator, the encoder produces 23,772 pulses during the conveyance of this amount (i.e., 12 inches) of web. Motor 84 is then de-energized. However, inertia drives the movable cylinder 16 for a distance after the motor is de-energized, and this may be taken into account to improve the accuracy of the machine. Generally, the over-run is relatively consistent from sheet to sheet. Because of the encoder, the controller knows the exact distance that the motor 84 and movable surface 16 have rotated after de-energization of the motor. The controller can thus keep a running average of this over-run and de-energize the motor at the correct time just prior to conveying the desired length of web.
2. Severance: The motor polarity is reversed, and the motor is energized. At this point, the heating element on the severing device 20 is also energized, causing it to heat. As described above, reversal of the motor polarity causes the severing device/heated element to travel toward the movable surface 16, cutting the web as it makes contact with and urges the web against the movable surface. The severing device presses the web against the movable surface with enough force, combined with the heat from the wire, to effect severance of the web. The necessary force for Bubble Wrap® cushioning material is in the range of 20 to 60 pounds, and can be controlled by the amount of electrical current supplied to the motor 84. By controlling the current, the force of severing device 20 can be controlled not only at contact with web 12/movable surface 16, but also during transit from the device's outermost position to its severance position. Again, because of the encoder, the controller knows the position of the severing device in relation to the movable surface, so the force and speed can be kept low until it reaches a close proximity to the movable surface, where the force can then be increased as necessary to effect severance. This reduces the chance of operator injury by pinching between the bar and movable surface.
3. Return of Severing Device: The motor 84 is now operated in the forward direction (54) again for a short time to return the severing device to its outermost position (FIG. 11) and release the cut sheet. If desired or necessary, movable surface 16 may be driven a short distance to insure release of the cut sheet, e.g., into a container such as bin 38 (FIG. 1). The controller, in step 2, read the number of encoder pulses as the severing device was driven to the movable surface. This number is now compared with the number of pulses counted as the severing device is returned, and any difference is applied to the length of the next sheet to be cut. For example, if the controller sees 2,000 pulses while making the cut, and 2,500 pulses as the severing device returns, it means that the movable surface has driven the web forward enough to make 500 pulses.

When another sheet is selected, these 500 pulses will be subtracted from the total target length, so that the length will be correct. In some embodiments, the entire cut-off and return cycle takes less than 1 second to complete, with the movable surface conveying about 2 feet of web per second.

### Example 2 (Batch Mode)

In this mode, machine 10″ makes a pre-determined quantity of sheets of a pre-determined length, which an operator selects via an electronic controller. Machine 10″ then performs three basic sub-operations:
1. Web Conveyance: Identical to Single Mode operation as described above.
2. Severance: Identical to Single Mode operation as described above.
3. Resume Conveyance: Once the cut-off is complete, the motor is operated in the forward direction, which returns the severing device to the outermost position as above, but the motor continues to drive without pausing until the next sheet is in position to cut. The controller remembers the number of encoder pulses seen during the cut-off, and adds this to the target length of the next sheet. This takes into account that it takes the same number of pulses, therefore the same distance to return the severing device to the outermost position before the movable surface begins to move.

### Example 3 (Manual Mode)

In manual mode, the operator steps on a foot switch, or presses a button, which conveys the web until the foot switch or button is released. Severance is then performed as in the single mode of operation as described above. In manual mode, the operator can make sheets of varying length as desired.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A machine for severing a web, comprising:
a) a movable surface positioned such that the web may exert gravitational force against said movable surface, said movable surface providing frictional force against the web such that movement of said surface causes movement of the web, wherein, the gravitational force exerted by the web on said movable surface and the frictional force between the web and said movable surface are sufficient to allow said movable surface to convey the web; and
b) a severing mechanism to sever the web into selected lengths, said severing mechanism including a severing device that urges the web against said movable surface to effect the severance of the web.

2. The machine of claim 1, wherein said movable surface comprises a continuous surface that moves about a defined path.

3. The machine of claim 2, wherein said movable surface has a cylindrical shape.

4. The machine of claim 1, wherein said severing device urges the web against said movable surface in a direction that is substantially perpendicular to said surface.

5. The machine of claim 4, wherein said severing device moves in a substantially linear path of travel.

6. The machine of claim 1, further including a guide member adjacent said movable surface to define a path for movement of the web between said movable surface and said guide member.

7. The machine of claim 6, wherein
the web has upper and lower surfaces, the lower surface being in contact with said movable surface; and
said guide member is in sliding contact with the upper surface of the web.

8. The machine of claim 1, further including a drive mechanism, said drive mechanism causing
a) said movable surface to move; and
b) said severing device to urge the web against said movable surface.

9. The machine of claim 8, wherein said drive mechanism comprises
a) a reversible drive source capable of producing a driving force in a first direction and in an opposing second direction; and
b) a drive transmission that interconnects said movable surface and said severing mechanism to said reversible drive source such that
(1) said drive source causes said movable surface to move when said drive source produces a driving force in said first direction, and
(2) said drive source causes said severing device to urge the web against said movable surface when said drive source produces a driving force in said second direction.

10. The machine of claim 8, wherein said reversible drive source is movably supported by said transmission for movable adjustment of said drive mechanism between
a) a conveyance mode, when said drive source produces a driving force in said first direction; and
b) a severance mode, when said drive source produces a driving force in said second direction.

11. The machine of claim 8, wherein
said movable surface comprises a continuous surface that moves about a defined path; and
said drive mechanism is positioned interiorly of said path.

12. The machine of claim 11, wherein
said movable surface is in the form of a rotatable cylinder; and
said drive mechanism is positioned inside of said cylinder such that said cylinder rotates about said drive mechanism.

13. The machine of claim 1, wherein said movable surface comprises an elastomeric material.

14. The machine of claim 1, wherein said severing device comprises a heating element capable of reaching a temperature sufficient to sever the web.

15. The machine of claim 14, wherein
a) said heating element reaches said web-severance temperature when electrical current flows therethrough;
b) said heating element is configured such that only a contact portion thereof makes contact with and effects severance of the web; and
c) said severing device further includes two or more electrical nodes that are connectable with a source of electricity and in electrical communication with said heating element, said nodes being positioned relative to said heating element such that electrical current flows substantially only through said contact portion of said heating element.

16. A machine for severing a web, comprising:
a) a movable surface positioned such that the web may exert gravitational force against said movable surface, said movable surface providing frictional force against the web such that movement of said surface causes movement of the web;
b) a guide member adjacent said movable surface to define a path for movement of the web between said movable surface and said guide member, said guide member being in sliding contact with the web; and
c) a severing mechanism to sever the web into selected lengths, said severing mechanism including a severing device that urges the web against said movable surface to effect the severance of the web.

17. The machine of claim 16, wherein
the web has upper and lower surfaces, the lower surface being in contact with said movable surface; and
said guide member exerts a force against the upper surface of the web.

18. The machine of claim 16, wherein said severing device urges the web against said movable surface in a direction that is substantially perpendicular to said surface.

19. The machine of claim 18, wherein said severing device moves in a substantially linear path of travel.

20. The machine of claim 16, wherein said severing device comprises:
a) a heating element capable of reaching a temperature sufficient to sever the web when electrical current flows therethrough, said heating element being configured such that only a contact portion thereof makes contact with and effects severance of the web; and
b) two or more electrical nodes that are connectable with a source of electricity and in electrical communication with said heating element, said nodes being positioned relative to said heating element such that electrical current flows substantially only through said contact portion of said heating element.

21. A device for severing a web, comprising:
a) a heating element capable of reaching a temperature sufficient to sever the web when electrical current flows therethrough, said heating element being configured such that only a contact portion thereof makes contact with and effects severance of the web; and
b) two or more electrical nodes that are connectable with a source of electricity and in electrical communication with said heating element, said nodes being positioned relative to said heating element such that electrical current flows substantially only through said contact portion of said heating element.

22. The device of claim 21, wherein:
said device further includes a support member for said heating element; and
said electrical nodes space said contact portion of said heating element from said support member.

23. The device of claim 22, wherein said electrical nodes resiliently bias said contact portion of said heating element away from said support member.

24. The device of claim 21, wherein
said device further includes a support member for said heating element; and
said heating element is attached to said support member by a pair of tension-control units, whereby, tension is maintained in said heating element over a predetermined temperature range at which said heating element is operated.

25. The device of claim 24, wherein said electrical nodes are positioned between said pair of tension-control units.
